(19) United States
(12) Patent Application Publication
(10) Pub. No.: US 2015/0125300 A1
(43) Pub. Date: May 7, 2015

(54) ROTOR HUB FOR A ROTORCRAFT

(71) Applicant: Bell Helicopter Textron Inc., Fort Worth, TX (US)

(72) Inventors: Frank B. Stamps, Colleyville, TX (US); Richard Rauber, Euless, TX (US); Hunter Jay Davis, Iowa Park, TX (US)

(73) Assignee: BELL HELICOPTER TEXTRON INC., Fort Worth, TX (US)

(21) Appl. No.: 14/072,511

(22) Filed: Nov. 5, 2013

(51) Int. Cl. B64C 27/37; B64C 27/35

(52) U.S. Cl. CPC B64C 27/37; B64C 27/35
USPC 416/134 A

(57) ABSTRACT

A drive mechanism for a rotary aircraft includes an outer drive member having a plurality of drive trunnions extending therefrom; a middle drive member resiliently coupled to the outer drive member; and an inner drive member resiliently coupled to the middle drive member.

### BACKGROUND

1. Technical Field

The present disclosure relates to a rotor hub for a rotorcraft.

2. Description of Related Art

One type of conventional rotor hub, such as the rotor hub described in U.S. Pat. No. 6,296,444, can utilize a plurality of trunnions coupled to drive links configured for transferring torque between the rotor mast and the rotor yoke. During operation the rotor yoke can tilt due to an operational input, such as due to a cyclic pitch change of the rotor blades. The tilting of the rotor yoke can cause one or more of the drive links to lift vertically, which in turn can cause the remaining drive links to pull laterally toward the rotor mast axis. Since the tilting of the rotor yoke can oscillate more than once per revolution of the rotor hub, the lateral shifting movement of the drive links creates a whirling lateral in-plane shear force on the rotor mast that is realized as a large oscillatory vibration in the aircraft.

There is a need for an improved rotor hub that avoids the large in-plane oscillatory vibrations.

### DESCRIPTION OF THE DRAWINGS

The novel features believed characteristic of the embodiments of the present disclosure are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective view of a tilt rotor aircraft in helicopter mode, according to an example embodiment;

FIG. 2 is a perspective view of a tilt rotor aircraft in airplane mode, according to an example embodiment;

FIG. 3 is a perspective view of a rotor hub, according to an example embodiment;

FIG. 4 is a partially exploded view of a rotor hub, according to an example embodiment;

FIG. 5 is an exploded view of a drive mechanism, according to an example embodiment;

FIG. 6 is a perspective view of a drive mechanism, according to an example embodiment;

FIG. 7 is a top plan view of a drive mechanism, according to an example embodiment;

FIG. 8 is a top plan view of a rotor hub, according to an example embodiment; and

FIG. 9 is a graphical illustration of loading within a rotor hub.

### DESCRIPTION OF THE PREFERRED EMBODIMENT

Illustrative embodiments of the apparatus are described below. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

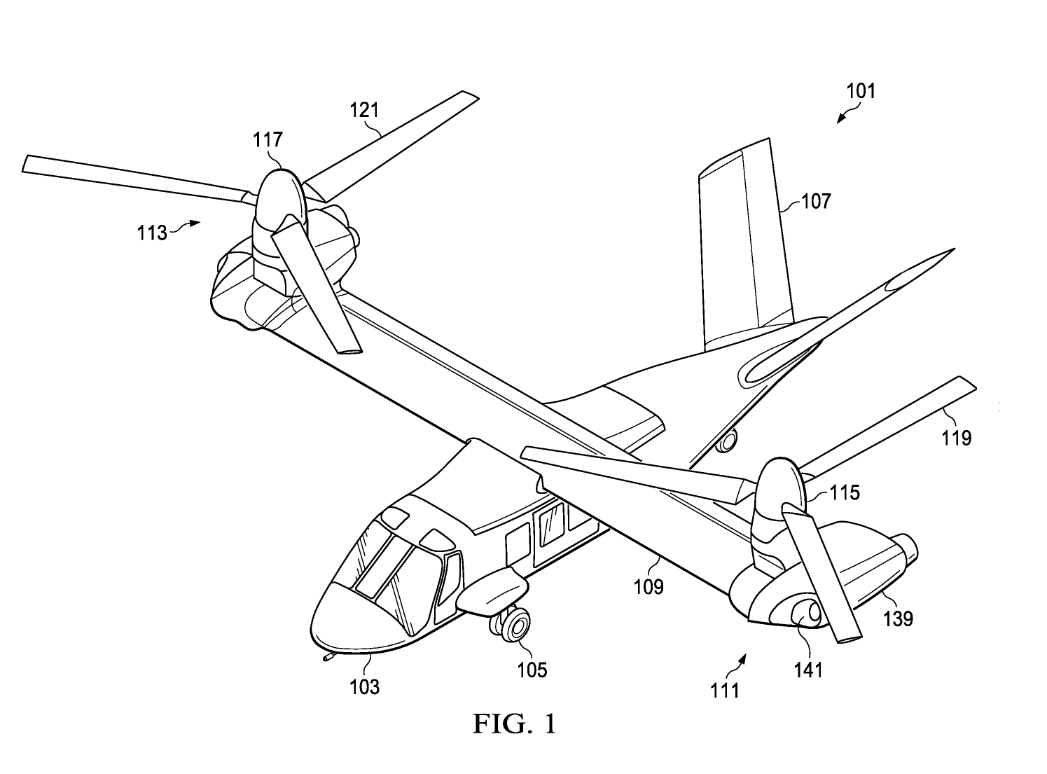

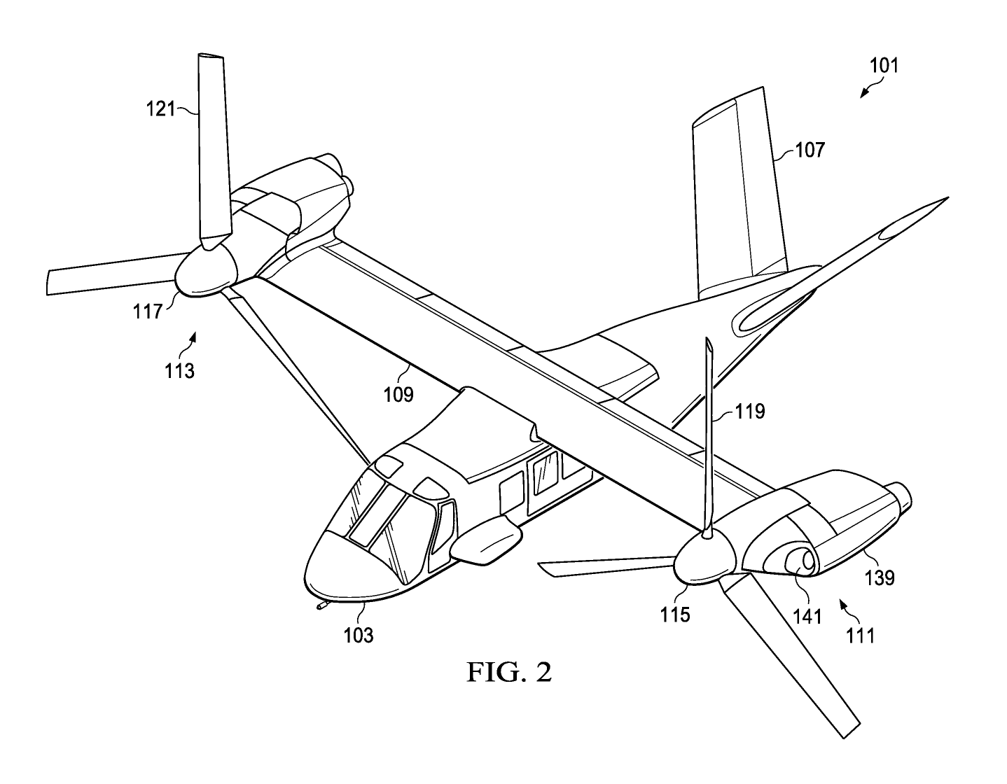

Referring to FIGS. 1 and 2 in the drawings, a tilt rotor aircraft 101 is illustrated. Tilt rotor aircraft 101 can include a fuselage 103, a landing gear 105, a tail member 107, a wing 109, a propulsion system 111, and a propulsion system 113. Each propulsion system 111 and 113 can include a fixed engine and a rotatable proprotor 115 and 117, respectively. Each rotatable proprotor 115 and 117 have a plurality of rotor blades 119 and 121, respectively, associated therewith. The position of proprotors 115 and 117, as well as the pitch of rotor blades 119 and 121, can be selectively controlled in order to selectively control direction, thrust, and lift of tilt rotor aircraft 101.

FIG. 1 illustrates tilt rotor aircraft 101 in helicopter mode, in which proprotors 115 and 117 are positioned substantially vertical to provide a lifting thrust. FIG. 2 illustrates tilt rotor aircraft 101 in an airplane mode, in which proprotors 115 and 117 are positioned substantially horizontal to provide a forward thrust in which a lifting force is supplied by wing 109. It should be appreciated that tilt rotor aircraft can be operated such that proprotors 115 and 117 are selectively positioned between airplane mode and helicopter mode, which can be referred to as a conversion mode. Proprotors 115 and 117 can include a rotor hub system, such as rotor hub system 301 disclosed further herein.

It should be appreciated that tilt rotor aircraft 101 is merely illustrative of a wide variety of aircraft that can implement the apparatuses disclosed herein, such as rotor hub system 301. Other aircraft implementation can include hybrid aircraft, conventional rotorcraft, unmanned aircraft, gyrocopters, other variants of tilt rotor aircraft, and a variety of other helicopter configurations, to name a few examples.

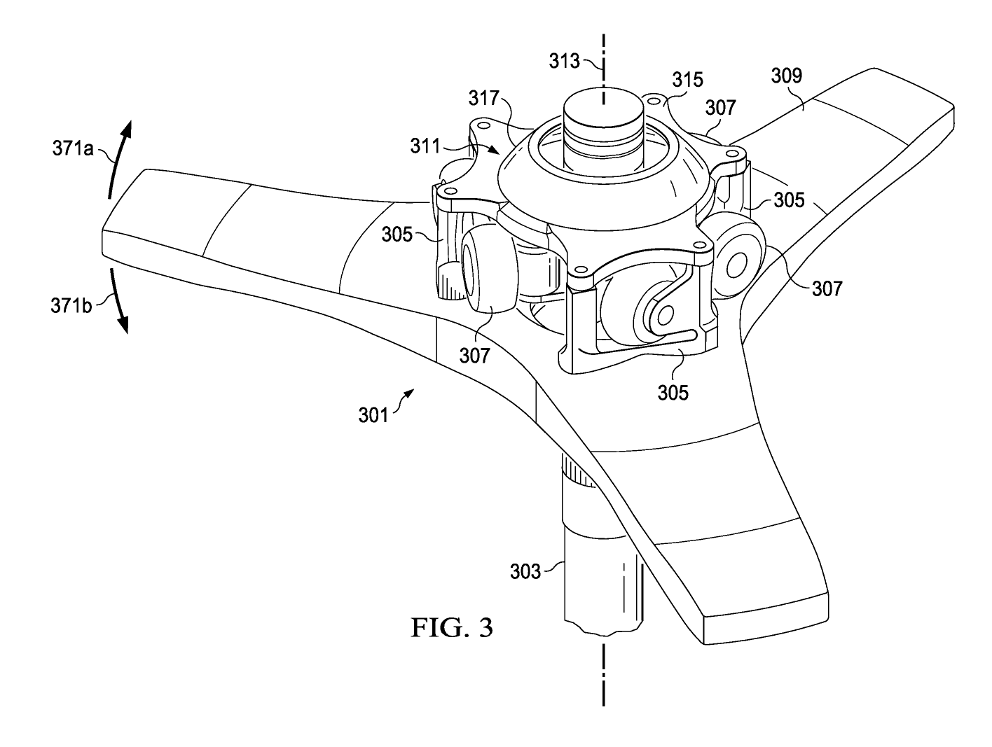

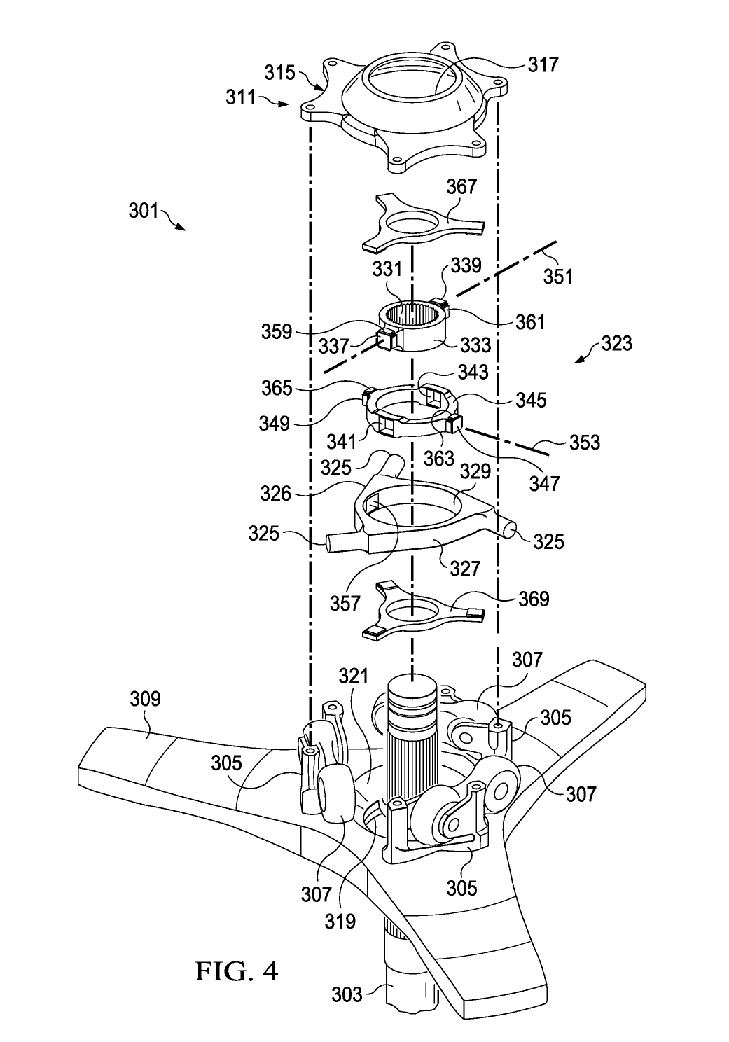

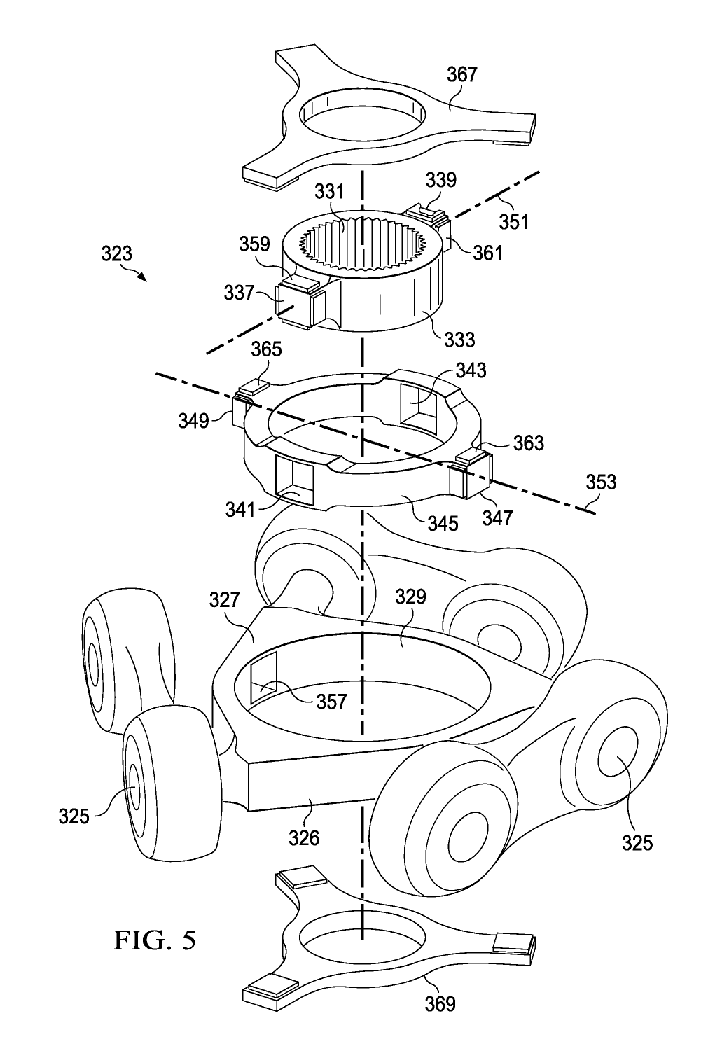

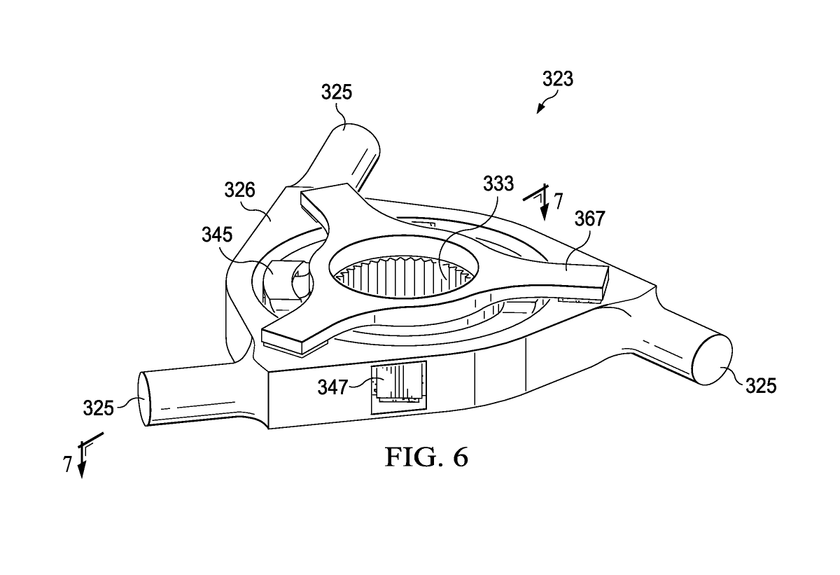

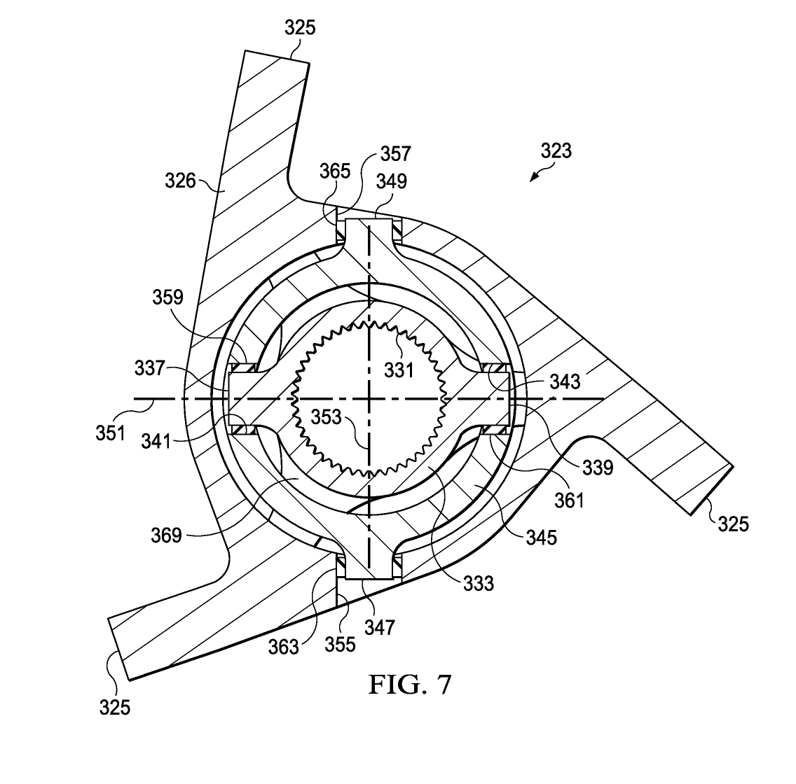

Referring now also to FIGS. 3-8, a rotor hub system 301 is illustrated in further detail. In such an embodiment, the rotor hub system 301 may generally comprise a mast 303, a hub spring assembly 311, and a yoke 309. In an embodiment, the rotor hub system 301 is configured to rotate about the mast 303. In an embodiment, the mast 303 may be configured to transfer a rotational force and/or torque (e.g., from a transmission, a drive system, etc.) to the rotor hub system 301. In an embodiment, the mast 303 may generally comprise one or more interfacing surfaces (e.g., splines, grooves, etc.) and may extend along a longitudinal axis 313. In an embodiment, the diameter of the mast 303 may be sized for an application (e.g., an aircraft) as would be appreciated by one of ordinary skill in the art upon viewing this disclosure.

Hub spring assembly 311 can include an upper portion having an upper plate 315, an upper spring member 317, and an upper inner member. Hub spring assembly 311 also includes a lower portion having a lower plate coupled to yoke 309, a lower spring member 321, and a lower inner member 319. Upper plate 315, upper inner member, lower plate, and lower inner member 319 are rigid members. In contrast, upper spring member 317 and lower spring member 321 can include alternating shim layers and elastomeric layers that are collectively configured to react operational loads through deflection of the elastomeric layers. The exact material of the elastomeric layers is implementation specific; for example, elastomeric materials, such as rubber, can be formulated in a variety of implementation specific properties, such as elasticity. Further, it should be appreciated that the shim layers can be of any desired rigid material. In the preferred embodiment, the shim layers are of a metal material, but alternative embodiments can include other rigid materials, such as a composite material.

The upper spring member 317 and the lower spring member 321 of hub spring assembly 311 are configured to react solely or in any combination: thrust forces, shear forces, and moment forces. During operation, a collective change in pitch of rotor blades 119 can impart a thrust load between yoke 309 and rotor mast 303 that which upper spring member 317 and the lower spring member 321 of hub spring assembly 311 is configured to react. Similarly, a cyclic change in the pitch of rotor blades 119 can cause shear and moment loads between yoke 309 and rotor mast 303 which upper spring member 317 and the lower spring member 321 of hub spring assembly 311 are configured to react. It should be appreciated that other operational forces can also cause thrust, shear, and moment loads between yoke 309 and rotor mast 303.

Torque is transferred from rotor mast 303 to yoke 309 via a drive mechanism 323. Drive mechanism 323 can include a plurality of drive links 307 that provide a torque path from trunnions 325 to pillow blocks 305. Each trunnion 325 represents an arm extension from a body portion 327 of an outer drive member 326 having an at least partially hollow portion 329. Torque is transferred from mast 303 to an interior splined portion 331 of an inner drive member 333. Inner drive member 333 has a body portion with a first member 337 and a second member 339 extending therefrom. First member 337 and second member 339 extend in opposite directions along an axis 351. First member 337 and second member 339 are coupled to a first opening 341 and a second opening 343, respectively, of a middle drive member 345. Middle drive member 345 includes a first member 347 a second member 349 that extend from a body portion in opposite directions along an axis 353. First member 347 and second member 349 are coupled to a first opening 355 and a second opening 357, respectively, of a middle drive member 345. In the example embodiment, axis 353 is approximately 90° to axis 351.

An elastomeric member 359 is secured to the outer surfaces of first member 337 and the inner surfaces of first opening 341. In the example embodiment, first member 337 is a square shaped extension while first opening 341 is a square shaped opening, thus elastomeric member 359 can be divided into four units, one unit for each side. Similarly, an elastomeric member 361 is secured to the outer surfaces of second member 339 and the inner surfaces of second opening 343. In the example embodiment, second member 339 is a square shaped extension while second opening 343 is a square shaped opening, thus elastomeric member 361 can be divided into four units, one unit for each side. Similarly, an elastomeric member 363 is secured to the outer surfaces of first member 347 and the inner surfaces of first opening 355. In the example embodiment, first member 347 is a square shaped extension while first opening 355 is a square shaped opening, thus elastomeric member 363 can be divided into four units, one unit for each side. Similarly, an elastomeric member 365 is secured to the outer surfaces of second member 349 and the inner surfaces of second opening 357. In the example embodiment, second member 349 is a square shaped extension while second opening 357 is a square shaped opening, thus elastomeric member 365 can be divided into four units, one unit for each side. In one example embodiment, elastomeric members 359, 361, 363, and 365 are made with solid elastomeric material. In another example embodiment, elastomeric members 359, 361, 363, and 365 include alternating layers of elastomeric material and shim material that are collectively configured to provide for resilient shear deflection.

Drive mechanism 323 can also include an upper plate 367 and a lower plate 369 configured to contain inner drive member 333 and middle drive member 345 to within a plane of outer drive member 326.

Drive links 307 can be disposed radially and equally spaced about the yoke 309. In the example embodiment, each drive link 307 is coupled to the trunnions 325 of outer drive member 326 and to yoke 309 via pillow blocks 305. In the example embodiment, drive links 307 are configured to provide the required degrees of freedom for yoke 309 and attached rotor blades (shown in FIGS. 1 and 2) to flap in/out of the plane of the yoke 309, such as in flapping directions 371a and 371b (shown in FIG. 3). Drive links 307 can accommodate other articulation or movement as would be appreciated by one of ordinary skill in the art upon viewing this disclosure. Drive links 307 can include alternating layers of rubber (or other elastomeric material) and metal arranged in a dog-bone configuration. In one embodiment, the drive links 307 can be as described in U.S. Pat. No. 5,186,686, which is hereby incorporated by reference. Typically, drive links 307 are stiff in the torque carrying direction, but relatively soft in the radial direction.

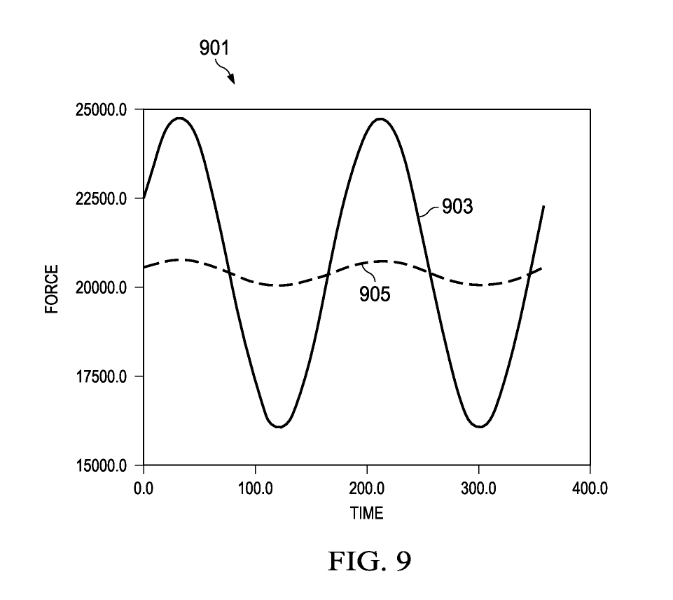

During operation of the aircraft, such as tilt rotor aircraft 101, rotor hub 301 is rotated about axis 313. Aircraft operation can cause one or more dynamic movements with rotor hub 301, such as a tilting of yoke 309, which can be caused by a cyclic pitch input, for example. Such a tilting of yoke 309, if left untreated, can cause a large oscillatory load. For example, if arm 309a of yoke 309 were to flap upwards causing a tilting of yoke 309, then the differences in the lengths (as measure normal to the mast axis 313) of drive links 307 would cause mast 303 to be pulled radially normal to mast axis 313 if outer drive member 326 were rigid to mast 303. Referring also to FIG. 9, a graph 901 includes a solid line 903 illustrating loading in drive links 307 if outer drive member 326 were to be rigidly coupled to mast 303 within the plane of yoke 309. However, one object of the embodiments disclosed herein is to substantially reduce the oscillatory loading illustrated by solid line 903 in graph 901.

Drive mechanism 323 is configured to substantially reduce the oscillatory loading that would otherwise occur if outer drive member 326 were rigidly coupled to mast 303. Drive mechanism 323 is uniquely configured such that instead of outer drive member 326 being rigidly coupled to mast 303, outer drive member 326 is resiliently coupled to middle drive member 345 via elastomeric members 363 and 365, thereby creating a first degree of freedom along axis 353 through shearing deflection of elastomeric members 363 and 365. Further, middle drive member 345 is resiliently coupled to inner drive member 333 via elastomeric members 359 and 361, thereby creating a second degree of freedom along axis 351 through shearing deflection of elastomeric members 359 and 361. Thus, the combination and interaction of outer drive member 326, middle drive member 345, and inner drive member 333 allow the oscillatory loads to be reduced by accommodating the lateral pulling motion of the drive links 307 during a tilting of yoke 309. It should be appreciated that the combination of outer drive member 326, middle drive member 345, and inner drive member 333 can accommodate motions in any direction within the plane of drive mechanism 323.

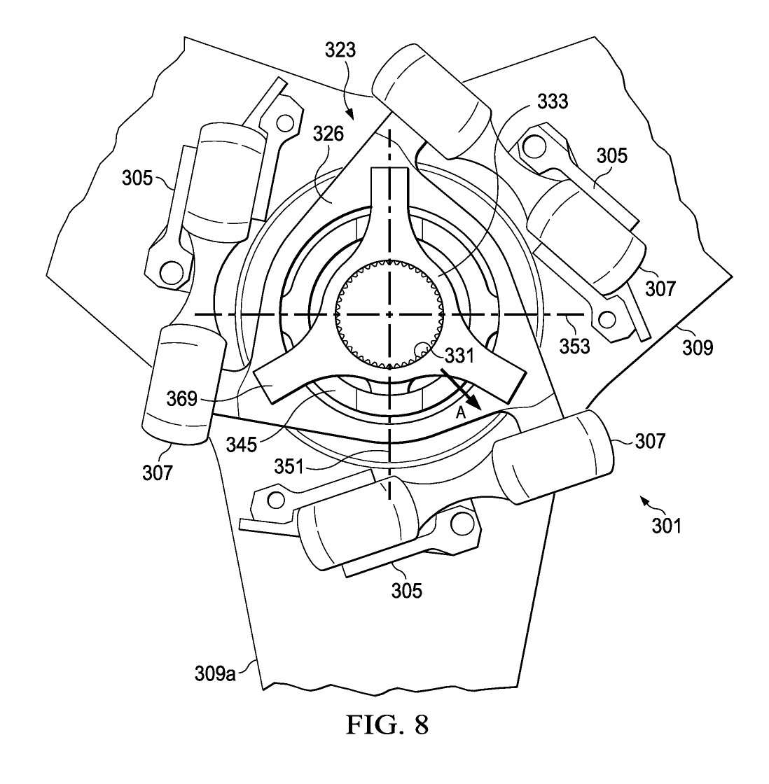

Referring in particular to FIG. 8, one operation example can include one or more drive links 307 pulling outer drive member 326 in a direction A within a plane of drive mechanism 323. As a result, outer drive member partially translates relative to middle drive member 345 and inner drive member 333 along axis 353 through a resilient deflection of elastomeric members 363 and 365. Further since direction A also includes a translational component along axis 351, both outer drive member 326 and middle drive member 345 translate relative to inner drive member 333 through a resilient deflection of elastomeric members 359 and 361. Since the loading direction can be constantly changing as the yoke 309 (which can be tilted) rotates around mast 303, the movement of outer drive member 326 can exhibit a whirling resilient displacement relative to inner drive member 333. Such a result substantially reduces the oscillatory loading in a conventional mechanical system. Referring again to FIG. 9, a graph 901 includes a dashed line 903 illustrating loading in drive links 307 of rotor hub 301 with drive mechanism 323. As illustrated by lines 905 and 903, the oscillatory load is substantially reduced by drive mechanism 323.

It should be appreciated that the size, shape, thickness, material, and other characteristics of elastomeric members 359, 361, 363, and 365 are implementation specific. In one embodiment, shims can be utilized to promote the shearing the elastomeric material elastomeric members 359, 361, 363, and 365.

The particular embodiments disclosed above are illustrative only, as the apparatus may be modified and practiced in different but equivalent manners apparent to those skilled in the art having the benefit of the teachings herein. Modifications, additions, or omissions may be made to the apparatuses described herein without departing from the scope of the invention. The components of the apparatus may be integrated or separated. Moreover, the operations of the apparatus may be performed by more, fewer, or other components.

Furthermore, no limitations are intended to the details of construction or design herein shown, other than as described in the claims below. It is therefore evident that the particular embodiments disclosed above may be altered or modified and all such variations are considered within the scope and spirit of the application. Accordingly, the protection sought herein is as set forth in the claims below.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

1. A drive mechanism for a rotary aircraft, the drive mechanism comprising:
an outer drive member having a plurality of drive trunnions extending therefrom;
a middle drive member resiliently coupled to the outer drive member;
an inner drive member resiliently coupled to the middle drive member.

2. The drive mechanism according to claim 1, further comprising:
a rotor mast coupled to the inner drive member.

3. The drive mechanism according to claim 1, further comprising:
a rotor mast splined to the inner drive member.

4. The drive mechanism according to claim 1, further comprising:
a plurality of drive links, each drive link being coupled to a rotor yoke and one of the plurality of drive trunnions.

5. The drive mechanism according to claim 1, wherein the inner drive member includes a first member and a second member each extending from a body portion along a first axis.

6. The drive mechanism according to claim 5, wherein the first member and the second member have a square cross sectional shape.

7. The drive mechanism according to claim 5, wherein the first member and the second member are resiliently coupled to a first opening and a second opening, respectively, of the middle drive member with a first elastomeric member and a second elastomeric member.

8. The drive mechanism according to claim 7, wherein the first elastomeric member and the second elastomeric member are configured to deflect and allow relative motion between the inner drive member and the middle drive member in a direction along the first axis.

9. The drive mechanism according to claim 1, wherein the middle drive member includes a third member and a fourth member each extending from a main portion along a second axis.

10. The drive mechanism according to claim 9, wherein the third member and the fourth member have a square cross sectional shape.

11. The drive mechanism according to claim 9, wherein the third member and the fourth member are resiliently coupled to a third opening and a fourth opening, respectively, of the outer drive member with a third elastomeric member and a fourth elastomeric member.

12. The drive mechanism according to claim 11, wherein the third elastomeric member and the fourth elastomeric member are configured to deflect and allow relative motion between the middle drive member and the outer drive member in a direction along the second axis.

13. The drive mechanism according to claim 1, further comprising:
a top plate; and
a lower plate.

14. The drive mechanism according to claim 1, wherein outer drive member, the middle drive member, and the inner drive member are located in a single plane.

15. The drive mechanism according to claim 14, wherein the single plane is normal to a rotational axis of a rotor mast.

16. The drive mechanism according to claim 1, wherein torque from the rotor mast is carried to a rotor yoke through the inner drive member, the middle drive member, and the outer drive member.

17. A rotor hub for an aircraft, the rotor hub comprising:
a yoke being configured for coupling a plurality of rotor blades thereto;
a rotor mast;
a drive mechanism for transferring torque between the rotor mast and the yoke;
the drive mechanism comprising:
an outer drive member having a plurality of drive trunnions extending therefrom;
a middle drive member resiliently coupled to the outer drive member; and
an inner drive member resiliently coupled to the middle drive member;
a plurality of drive links coupled to the yoke and to trunnions of the outer drive member.

18. The rotor hub according to claim 17, wherein the aircraft is a tilt rotor aircraft.

19. The rotor hub according to claim 17, wherein the aircraft is a helicopter.

20. The rotor hub according to claim 17, wherein outer drive member is configured to translate relative to the middle member along a first axis, and wherein the outer drive member and the middle drive member are configured to collectively translate relative to the inner drive member about a second axis.
